(19) United States
(12) Patent Application Publication
(10) Pub. No.: US 2005/0223635 A1
(43) Pub. Date: Oct. 13, 2005

(54) System and method for collecting landscape trimmings

(76) Inventor: Joseph Russo, Chicago Hts., IL (US)

Correspondence Address: MCANDREWS HELD & MALLOY, LTD, 500 WEST MADISON STREET, SUITE 3400, CHICAGO, IL, 60661, US

(21) Appl. No.: 10/822,334

(22) Filed: Apr. 12, 2004

(51) Int. Cl. A01G 13/00

(52) U.S. Cl. 47/10

(57) ABSTRACT

Certain embodiments of the present invention provide a system and method for collecting landscape trimmings. A plurality of rigid pieces adjoin to form a receptacle around an object. The object may be a shrub, bush, or tree, for example. The receptacle has an opening to allow the pieces to surround the object. The receptacle also has an outer raised edge and an inner raised edge for containing the landscape trimmings.

### BACKGROUND OF THE INVENTION

The present invention generally relates to a system and method for collecting landscape trimmings. In particular, the present invention relates to a system and method for collecting and disposing landscape trimmings of bushes, trees, shrubs or other trimmable object.

General landscape maintenance includes clipping landscape objects, such as bushes, trees, or shrubs. As the landscape objects are clipped, landscape trimmings generally fall to the ground. Also, as part of landscape maintenance, one typically rakes or picks up the landscape trimmings from the ground. In order facilitate easy clean-up of landscape trimmings, a device may be placed around the landscape object to prevent the landscape trimmings from reaching the ground. Typically, the device is a piece of flexible sheeting that surrounds the landscape object.

Current devices made from flexible sheeting are clumsy and difficult to use. Positioning current flexible sheeting devices to surround an object is time consuming and cumbersome. Typically, a user spreads a current flexible sheeting device around the object. The user then adjusts the flexible sheeting device to ensure the area surrounding the object is completely covered. The adjustment of the device may include stretching, spreading, or tucking the sheeting around or under the object to be clipped. Generally, the positioning adjustments are time consuming and awkward.

After clipping, a user may desire to dispose of the landscape trimmings. Disposing landscape trimmings utilizing current devices is also time consuming and cumbersome. In order to dispose of the landscape trimmings, the user typically attempts to manipulate the flexible sheeting from around the object without spilling the landscape trimmings. Generally, removing the device from around the object is awkward and difficult. The flexible sheeting may become entangled or snagged with the object, causing the flexible sheeting to be difficult to remove. Moreover, the flexible sheeting is difficult to manipulate with landscape trimmings on the flexible sheeting. Generally, landscape trimmings often spill onto the ground, creating extra work for the user. Current devices often allow landscape trimmings to spill during transportation for disposal, in a garbage can, for example.

Furthermore, typical flexible sheeting devices are difficult to move from one object to another. Often, more than one object is clipped during landscape maintenance. Moving and positioning the device from one object to another is often time consuming, as described above. Often the time to position and remove the flexible sheeting device is longer than the time needed to clip the object. If more than one object is to be clipped, the user may spend a substantial amount of time moving current devices from object to object.

Generally, the clumsy and awkward nature of using flexible sheeting to collect and dispose of landscape trimmings provides for a time consuming and unpleasant experience for a user. Positioning the device, removing the trimmings, and moving the flexible sheeting device from one object to another is often a burden. Therefore, a need exists for a system and method which may allow for easier collection and disposal of landscape trimmings. Such a system and method may allow for easier positioning, disposal, and removal of landscape trimmings, thus reducing the amount of time required to clip an object such as a tree, bush, shrub or other vegetation, for example.

### SUMMARY OF THE INVENTION

Certain embodiments of the present invention provide a system and method for allowing easy collection and disposal of landscape trimmings. In an embodiment, a system for collecting landscape trimmings comprises a plurality of rigid pieces. The pieces adjoin to form a receptacle around an object. The object may be any shrub, bush, tree, or other trimmable object. As the pieces adjoin, an opening for the object allows the receptacle to surround the object. The receptacle has an outer raised edge for containing the landscape trimmings. The receptacle also has an inner raised edge for containing the landscape trimmings. Preferably, the shape of the receptacle is circular, however, the receptacle may be any shape. Also, the receptacle may be comprised of any number of pieces, but is preferably comprised of two pieces. Preferably, the two pieces comprise two halves of a circle. The pieces may be made of any rigid material, including plastic or polypropylene.

In an embodiment, a method involves collecting landscape trimmings. The landscape trimmings are collected by adjoining a plurality of rigid pieces to form a receptacle around an object. The receptacle then acquires the landscape trimmings. The trimmings are contained by an inner raised edge and by an outer raised edge. The receptacle may then be separated without removing the landscape trimmings. A user may then utilize the pieces to dispose of the landscape trimmings.

The system and method of the invention allows for the an easier collection and disposal of landscape trimmings. Hence, landscape trimmings from bushes, shrubs, or trees, for example, may be easily collected and disposed.

### DESCRIPTION OF THE DRAWINGS

FIG. 1 illustrates a system for collecting landscape trimmings in accordance with an embodiment of the present invention.

FIG. 2 illustrates a flow chart for collecting landscape trimmings in accordance with an embodiment of the present invention.

FIG. 3 illustrates an example of an application of an embodiment of the present invention.

FIG. 4 illustrates a sectional view of an embodiment of the present invention.

FIG. 5 illustrates a sectional view of an embodiment of the present invention.

FIG. 6 illustrates an overhead view of an embodiment of the present invention.

FIG. 7 illustrates a side view of an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

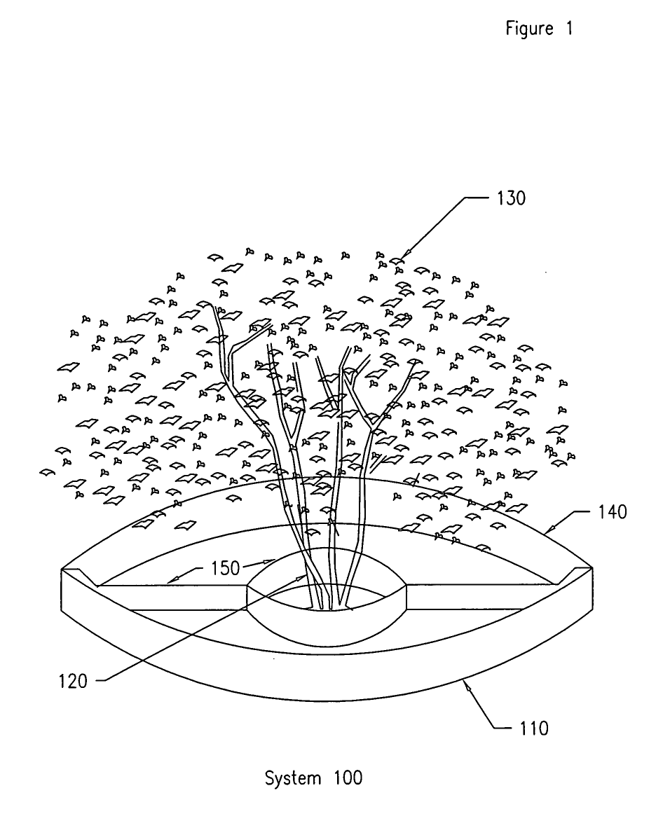

FIG. 1 illustrates a System 100 used according to an embodiment of the present invention. The System 100 illustrates a system for collecting landscape trimmings. The System 100 shows a receptacle 110, an object 120, and landscape trimmings 130. The receptacle 110 is composed of a plurality of rigid pieces. The rigid pieces adjoin to form the receptacle 110. The pieces allow the receptacle 110 to surround the object 120. As such, the pieces that form the receptacle 110 adjoin in such a way to allow an opening for the object 130 to protrude.

In an embodiment, the receptacle 110 may have an outer raised edge 140. As an example, in FIG. 1, the receptacle 110 is comprised of two pieces, each piece being a half circle. In the example provided in FIG. 1, the outer raised edge 140 traces the circumference of the receptacle 110. When the receptacle 110 is separated into individual pieces, the outer raised edge 140 traces the arc of the half circle formed by the individual piece. The outer raised edge 140 contains the landscape trimmings 130 to the receptacle 110. Similarly, in an embodiment, the receptacle 110 may have an inner raised edge 150. As an example in FIG. 1, the inner raised edge consists of the arc surrounding the opening. The inner raised edge 150 also consists of the portion of the pieces which adjoin to form the receptacle 110. As an example in FIG. 1, the inner raised edge 150 consists of the arc around the opening and the portions of the half circle which adjoin to form the receptacle 110. The inner raised edge 150 contains the landscape trimmings 130 to the receptacle 110.

As mentioned previously, the pieces composing the receptacle 110 are rigid. Rigid pieces provide for easy positioning, collection, and disposal of landscape trimmings 130. Also, rigid pieces provide structure for a user to easily transport the landscape trimmings 130, for example transporting the landscape trimmings to a garbage can. The rigid pieces may be easily disassembled for storage or for set up around a different object. As is further explained below, the rigid pieces may be slightly different sizes, allowing a first piece to be stored within a second piece. In an embodiment, the pieces are plastic. Specifically, the pieces may be polypropylene. In an embodiment, and further detailed below, the pieces should be at least one eighth of an inch thick.

In the embodiment shown in FIG. 1, the receptacle 110 is circular and composed of two pieces, each piece being half of the circle. The circular nature of the receptacle 110 allows the receptacle 110 to be equidistant at all points surrounding the object 120. The two pieces that are each half of the circle allow the pieces to be large enough for a user to easily manipulate the pieces to dispose of the landscape trimmings 130. One piece may be larger than the other to facilitate easy storage. For example, the pieces may be stored with the smaller piece placed inside the larger piece. Moreover, the use of two pieces allows for a easy positioning of the receptacle 110. Disassembly of the receptacle is also easy when use of the receptacle 110 is no longer required. As an example, if a user desires to clip more than one object, the user may quickly set up the device, clip the object, and dispose of the trimmings 130. The user may then quickly disassemble the receptacle 110 and set the up the receptacle 110 again at a different object 120. The object 120 may be a tree, shrub, or bush or any object a user desires to clip.

Although the System 100 illustrates a circular receptacle, the invention is not limited to a circular shape. Any shape which surrounds the object while allowing the object to protrude may be used. For example, a square or rectangular receptacle may be used. Moreover, the invention is not limited to two halves as shown in FIG. 1. Although two halves are preferred, any number of pieces may be used to form the receptacle. As such, an alternative embodiment of the invention, the receptacle may be a rectangular shape with four pieces adjoining to form the receptacle. Any shape or combination of pieces may be used to form the receptacle.

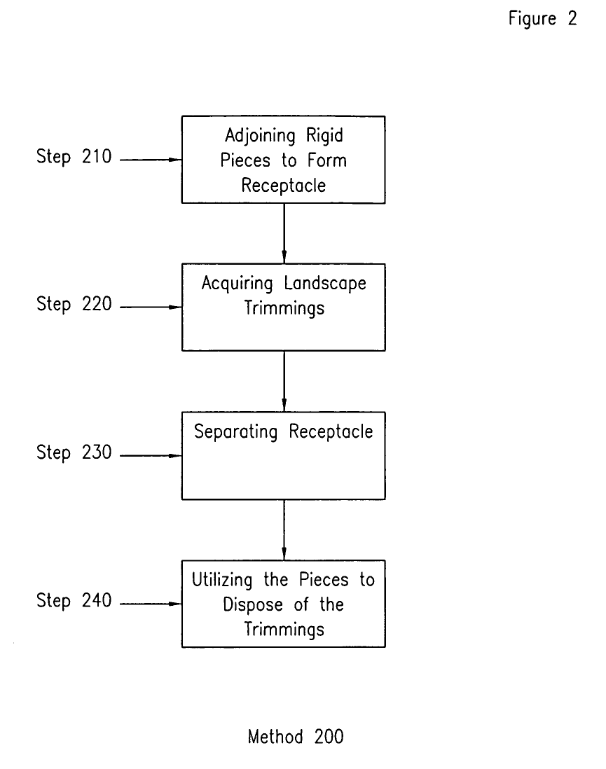

FIG. 2 illustrates a Method 200 of an embodiment of the present invention. The Method 200 illustrates a method of collecting landscape trimmings. At step 210 a plurality of rigid pieces adjoin to form a receptacle around an object. Next, at step 220, landscape trimmings acquire on the receptacle as a user clips an object. Also at step 220, the landscape trimmings are contained by an inner raised edge and by an outer raised edge on the receptacle. At step 230, the receptacle is separated without removing said landscape trimmings. A user may separate the receptacle by manually picking up a piece of the receptacle, for example. At step 240, a user may utilize the individual pieces of the receptacle to dispose of the landscape trimmings. The user may dispose of the landscape trimmings by separating the pieces from the receptacle and removing the trimmings. The trimmings may be removed by the user's hand pushing the trimmings into a trash receptacle, for example.

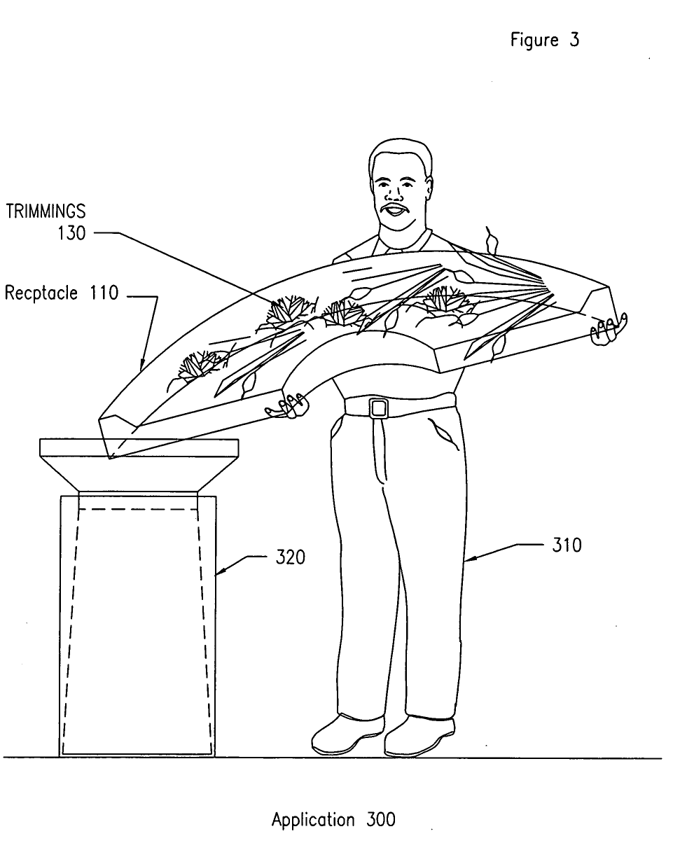

FIG. 3 illustrates an Application 300 of an embodiment of the present invention as an example. The Application 300 illustrates a user 310 disposing of landscape trimmings 130 in a trash container 320. For example, the user 310 may have placed the receptacle 110 around the object 120 as in FIG. 1. The user 310 may then clip the object 120 and allow the trimmings 130 to fall into the receptacle 110. The user 310 may then separate the receptacle 110, carry the pieces to a trash container 320 as in FIG. 3, and dispose of the trimmings 130. The user 310 may then carry the other pieces of the receptacle 110 to the trash container 320 for disposal of the trimmings 130. The user 310 may then assemble the pieces to form the receptacle 110 around the same object 120, assemble the pieces around a different object, or store the pieces for future use.

FIG. 3 is an example of an application of an embodiment of the invention. The application 300 shows the receptacle 110 as circular and consisting of two pieces. The invention is not limited by the Application 300.

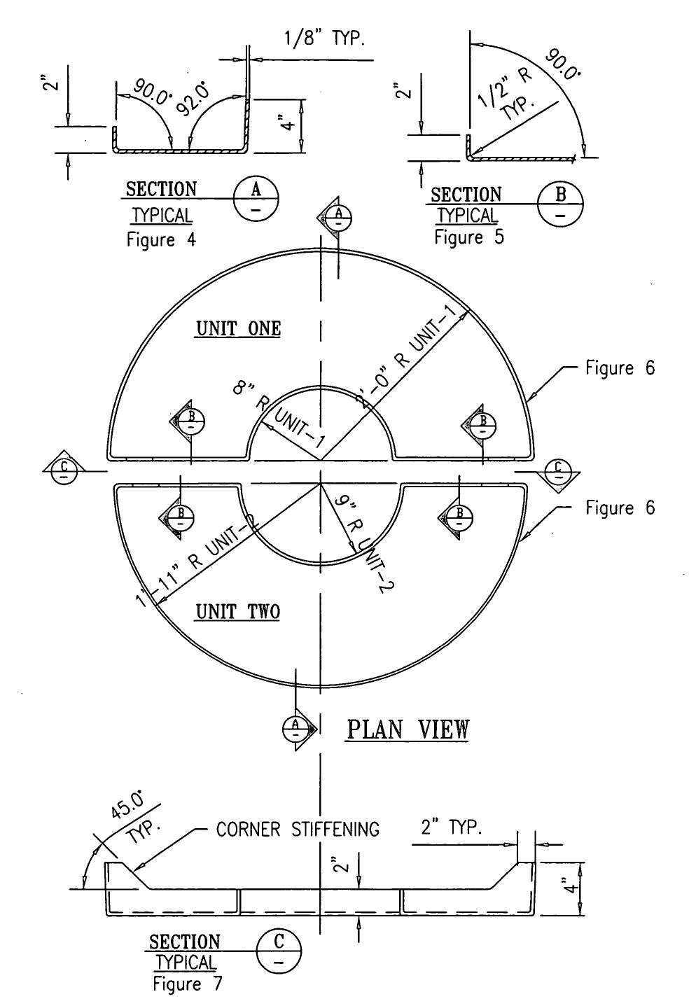

FIGS. 4, 5, 6, and 7 illustrate a schematic example of an embodiment of the present invention. The schematic example provided in FIGS. 4, 5, 6, and 7 are provided as an example of an embodiment of the invention. The invention as shown in FIGS. 4, 5, 6, and 7 is circular in shape and the receptacle consists of two pieces. However, the invention is in no way limited to the dimensions, shapes, or numerical values shown. Accordingly, any values, dimensions, shapes, or construction parameters may be used in accordance with the present invention.

FIG. 4 illustrates section view “A” of an embodiment of the present invention. Section view “A” illustrates the cross section “A” as labeled in FIG. 6. The inner raised edge is shown as having a height of two inches and the outer raised edge is shown having a height of four inches. Even utilizing other dimensions, in an embodiment, the inner raised edge may be shorter than the outer raised edge to allow the inner raised edge to more easily fit beneath the object. The inner raised edge is angled 90 degrees relative to the receptacle base and the outer raised edge is angled 92 degrees relative to the receptacle base. The dimensions and numerical values are provided as an example only and the invention is not limited to such numerical values.

FIG. 5 illustrates a section view “B” of an embodiment of the present invention. Section view “B” illustrates the cross section “B” as labeled in FIG. 6. FIG. 5 shows the inner raised edge having a height of two inches. The inner raised edge as shown in FIG. 5 illustrates the inner raised edge that traces the adjoining portion of the piece. Also, the angle from the receptacle base to the inner raised edge is shown as 90 degrees. The dimensions and numerical values are provided as an example only and the invention is not limited to such numerical values.

FIG. 6 illustrates an overhead view of an embodiment of the present invention. FIG. 6 illustrates the receptacle as divided into unit one and unit two. A circular opening is shown in FIG. 6. As two halves are adjoined, the object would protrude through the opening.

As is illustrated by the dimensions, unit one has a radius of 2′-0″ to the outer raised edge and unit two has a radius of 1′-11″ to the outer raised edge. Unit one has a radius of 8″ to the inner raised edge and unit two has a radius of 9″ to the inner raised edge. These dimensions provide an example of receptacle measurements. However, in this example, the dimensions of unit two allow unit two to easily fit inside unit one. Therefore, in an embodiment, the pieces may be different sizes to facilitate easy storage.

FIG. 7 illustrates a side view “C” of an embodiment of the present invention. Section view “C” illustrates the cross section “C” as labeled in FIG. 6. The side view shows the inner raised edge and the outer raised edge. Also shown, the outer raised edge and the inner raised edge may be angled toward the base of the receptacle for stability and safety. For example, in FIG. 7 the outer raised edge is shown at a 45 degree angle in connection with the receptacle base. In the embodiment shown, the inner raised edge is shown with a height of two inches. The inner raised edge also may angle at 45 degrees to the receptacle base. As mentioned previously, all dimensions are only an example and any dimensions may be used in implementing the invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1) A system for collecting landscape trimmings, said system comprising:
a plurality of rigid pieces, said pieces adjoining to form a receptacle around an object, said receptacle having an opening for said object allowing said receptacle to surround said object;
an outer raised edge on said receptacle for containing said landscape trimmings to said receptacle; and
an inner raised edge on said receptacle for containing said landscape trimmings to said receptacle.

2) The system of claim 1, wherein said receptacle is circular.

3) The system of claim 1, wherein said receptacle is comprised of two pieces.

4) The system of claim 3, wherein said receptacle is circular and said pieces comprise two halves of a circle.

5) The system of claim 1, wherein said pieces are plastic.

6) The system of claim 5, wherein said plastic is polypropylene.

7) The system of claim 1, wherein said object is a shrub, bush, or tree.

8) The system of claim 1, wherein the pieces may be different sizes to facilitate storage.

9) A method for collecting landscape trimmings, said method comprising:
adjoining a plurality of rigid pieces to form a receptacle around an object;
acquiring landscape trimmings on said receptacle, said trimmings being contained by an inner raised edge and by an outer raised edge;
separating said receptacle without removing said landscape trimmings;
utilizing said pieces to dispose of said landscape trimmings.

10) The method of claim 9, wherein said receptacle is circular.

11) The method of claim 9, wherein said receptacle is comprised of two pieces.

12) The method of claim 11, wherein said receptacle is circular and said pieces comprise two halves of a circle.

13) The method of claim 9, wherein said pieces are plastic.

14) The method of claim 13, wherein said plastic is polypropylene.

15) The method of claim 9, wherein said object is a shrub, bush, or tree.

16) The method of claim 9, wherein the pieces may be different sizes to facilitate storage.
